(19) United States
(12) Patent Application Publication
(10) Pub. No.: US 2015/0160137 A1
(43) Pub. Date: Jun. 11, 2015

(54) INSPECTION APPARATUS AND INSPECTION METHOD USING THE SAME

(71) Applicant: SAMSUNG ELECTRONICS CO., LTD., Suwon-si (KR)

(72) Inventors: Sung Hwa LEE, Anyang-si (KR); Tae Soo KIM, Yongin-si (KR); Hyun Soo JANG, Uiwang-si (KR); Jeong Min JO, Suwon-si (KR)

(73) Assignee: SAMSUNG ELECTRONICS CO., LTD., Suwon-si (KR)

(21) Appl. No.: 14/564,827

(22) Filed: Dec. 9, 2014

Related U.S. Application Data
(60) Provisional application No. 61/979,354, filed on Apr. 14, 2014.

(30) Foreign Application Priority Data
Dec. 9, 2013 (KR) 10-2013-0152102

(51) Int. Cl. G01N 21/75

(52) U.S. Cl. CPC G01N 21/75; G01N 2201/061

(57) ABSTRACT

An inspection apparatus including a detector configured to emit light to a chamber in which reaction of a sample and a reagent occurs and to detect an optical signal from the chamber, and a controller configured to acquire optical property data based on the detected optical signal and to predict inspection results using the optical property data acquired until a reference point in time.

### CROSS-REFERENCE TO RELATED APPLICATION

This application claims priority from Korean Patent Application No. 10-2013-0152102, filed on Dec. 9, 2013 in the Korean Intellectual Property Office and U.S. Patent Application No. 61/979,354, filed on Apr. 14, 2014 in the United States Patent and Trademark Office, the disclosures of which are incorporated herein by reference in their entireties.

### BACKGROUND

1. Field

Apparatuses and methods consistent with exemplary embodiments relate to an inspection apparatus for inspection of a sample and an inspection method using the same.

2. Description of Related Art

Various fields, such as environmental monitoring, food inspection, medical diagnosis, and the like, require apparatuses and methods for performing sample analysis. Small-scale automated equipment to rapidly analyze a sample has recently been developed.

To detect a target material included in a sample, a reagent having a specific reaction with the target material may be used. In addition, an optical sensor may be used to measure optical properties of a sample to determine the presence of a target material or to acquire the density of the target material based on the measured optical properties.

Sample analysis apparatuses may use an extremely small amount of sample and reagent for determining the presence of a target material and/or its density. Therefore, incorrect inspection results may be output when an appropriate amount of sample does not react with the reagent.

### SUMMARY

Aspects of one or more exemplary embodiments provide an inspection apparatus and an inspection method, which predict inspection results based on optical property data that is acquired in a normal state before an abnormal state occurs in an inspection chamber.

Additional aspects of one or more exemplary embodiments will be set forth in part in the description which follows and, in part, will be obvious from the description, or may be learned by practice of the invention.

According to an aspect of an exemplary embodiment, an inspection apparatus includes a detector configured to emit light to a chamber in which reaction of a sample and a reagent occurs and to detect an optical signal from the chamber, and a controller configured to acquire optical property data based on the detected optical signal and to predict inspection results using the optical property data acquired before a reference time.

The inspection apparatus may further include a storage configured to store a pattern of optical property data for each of the one or more inspection items. The pattern of optical property data, stored in the storage, may be determined based on an average value of the acquired optical property data.

The controller may be configured to search the storage for a pattern of optical property data corresponding to a current inspection item, and may predict the inspection results using the pattern of optical property data corresponding to the current inspection item and the optical property data acquired before the reference time.

The pattern of optical property data may be at least one selected from the group including a linear pattern, a log pattern, an exponential pattern, and a polynomial pattern.

The optical property may be at least one selected from the group including optical density, transmittance, reflectance, and luminance.

The inspection apparatus may further include a display configured to display the predicted inspection results.

In this case, the display may be configured to display a predetermined error percent of the predicted inspection results.

The controller may be configured to continuously acquire the optical property data until the inspection ends, and may be configured to determine an error percent by comparing final inspection results with the predicted inspection results, and the display may be configured to display the error percent.

The display may be configured to display an input button for the user to predict inspection results.

The reference point may be a time when the input button is selected.

The controller may acquire the optical property data until the reference time.

The detector may be configured to emit light having a main wavelength and to emit light having a sub wavelength, and the light having a main wavelength may have an optical property that varies according to the reaction of the sample and the reagent, and the light having a sub wavelength may have an optical property that is constant, and the controller may acquire the optical property data based on the main wavelength signal and the sub wavelength signal.

In this case, the reference time may be a time when an abnormal state occurs.

The controller may determine occurrence of the abnormal state based on variation of the sub wavelength signal.

The controller may be configured to monitor optical property variation of the light having the sub wavelength based on the sub wavelength signal, and may determine the occurrence of the abnormal state when the optical property of light having the sub wavelength varies beyond a critical value.

According to an aspect of another exemplary embodiment, there is provided an inspection method that includes acquiring optical property data based on an optical signal detected from a chamber in which reaction of a sample and a reagent occurs by emitting light to the chamber, and predicting inspection results using optical property data acquired before a reference time.

The predicting may include searching for a pattern of optical property data corresponding to a current inspection item, and predicting the inspection results using the pattern of optical property data corresponding to the current inspection item and the optical property data acquired before the reference point in time.

The pattern of optical property data may be determined as an average value of the acquired optical property data.

The pattern of optical property data may be at least one selected from the group including a linear pattern, a log pattern, an exponential pattern, and a polynomial pattern.

The optical property may be at least one selected from the group including optical density, transmittance, reflectance, and luminance.

The inspection method may further include displaying the predicted inspection results on a display.

The inspection method may further include displaying the predicted inspection results and the determined error percent on a display.

The inspection method may further include continuously acquiring the optical property data until inspection ends, and determining an error percent between final inspection results and the predicted inspection results.

The inspection method may further include displaying both the final inspection results and the determined error percent.

The acquiring may include emitting light having a main wavelength and an optical property that varies according to reaction of the sample and the reagent, and emitting light having a sub wavelength and an optical property that is constant, to the chamber, and detecting a main wavelength signal corresponding to the light having the main wavelength and a sub wavelength signal corresponding to the light having the sub wavelength, and acquiring the optical property data based on the main wavelength signal and the sub wavelength signal.

In this case, the inspection method may further include determining the occurrence of the abnormal state based on variation of the sub wavelength signal. The reference time may be a time when an abnormal state occurs.

The determining may include monitoring the optical property variation of the light having the sub wavelength based on the sub wavelength signal, and determining the occurrence of the abnormal state when the optical property of the light having the sub wavelength varies beyond a critical value. The determining may include determining that the sample and the reagent are abnormally received in the chamber when the sub wavelength signal varies beyond a critical value.

According to an aspect of another exemplary embodiment, there is provided an inspection apparatus including a chamber configured to combine a sample with a reagent to create a reaction, a light emitter configured to emit light toward the chamber, a light receiver configured to detect light from the chamber, and a controller configured to acquire optical property data from the light detected by the light receiver, and to determine a predicted optical property data based upon the acquired optical property data.

The light receiver may be configured to output an electrical signal corresponding to the intensity of the detected light. The light receiver may further be configured to, in response to detecting the light having a main wavelength, output a main wavelength signal corresponding to the intensity of the light having the detected main wavelength, and in response to detecting light having a sub wavelength, output a sub wavelength signal corresponding to the intensity of the light having the detected sub wavelength. The controller may be configured to acquire the optical property data based on the main wavelength signal and the sub wavelength signal.

The controller may be configured to determine that the device is in an abnormal state in response to a variation of the sub wavelength signal.

The light emitter and the light receiver may be located below the chamber.

### BRIEF DESCRIPTION OF THE DRAWINGS

These and/or other aspects of the exemplary embodiments will become apparent and more readily appreciated from the following description taken in conjunction with the accompanying drawings.

FIGS. 1A to 1C are views showing an external appearance of an inspection apparatus in accordance with an exemplary embodiment;

FIG. 2A is a view showing an external appearance of an analysis cartridge in accordance with an exemplary embodiment of the analysis cartridge for use in the inspection apparatus of FIGS. 1A to 1C;

FIG. 2B is an exploded view showing a configuration of an inspection portion of the analysis cartridge shown in FIG. 2A;

FIG. 3 is a control block diagram of the inspection apparatus in accordance with an exemplary embodiment;

FIG. 4A is an exemplary view schematically showing a detector corresponding to a detection chamber A of FIG. 2B;

FIG. 4B is an exemplary view schematically showing a detector corresponding to a detection chamber A of FIG. 2B;

FIG. 5 is a graph showing one example of optical property data;

FIGS. 6A to 6D are graphs showing a pattern of optical property data per inspection item;

FIG. 7 is a graph showing prediction of optical property data;

FIG. 8 is a view showing an example of an interface to display the progress of inspection;

FIG. 9 is a view showing an example of an interface to display final inspection results;

FIGS. 10A and 10B are views showing examples of an interface to display the progress of inspection;

FIG. 11 is a view showing an example of an interface to display the error percent of inspection results;

FIG. 12 is a control block diagram of an inspection apparatus in accordance with an exemplary embodiment;

FIGS. 13A and 13B are views showing an abnormal state;

FIG. 14 is a view showing an example of optical property variation when an abnormal state occurs in an inspection chamber;

FIG. 15 is a flowchart for an inspection method in accordance with an exemplary embodiment;

FIG. 16 is a flowchart for Operation 560 of FIG. 15; and

FIG. 17 is a flowchart for an inspection method in accordance with an exemplary embodiment.

### DETAILED DESCRIPTION

Various exemplary embodiments will be described more fully with reference to the accompanying drawings. An exemplary embodiment may, however, be embodied in many different forms and should not be construed as limited to exemplary embodiments set forth herein. Rather, these exemplary embodiments are provided so that this disclosure will be thorough and complete, and will fully convey the scope of the inventive concept to those skilled in the art. Like reference numerals refer to like elements throughout this application.

The terminology used herein is for the purpose of describing particular exemplary embodiments and is not intended to be limiting of the inventive concept. As used herein, the singular forms “a,” “an,” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Inspection apparatuses and methods may be used to inspect various samples, such as environmental samples, bio samples, food samples, and the like. In particular, when using an inspection apparatus for in vitro diagnosis of a bio sample collected from a human body, in vitro diagnosis may be rapidly implemented in inspection rooms and other places, such as home, offices, clinics, hospital rooms, emergency rooms, operating rooms, intensive care units, and the like, by users, including patients, doctors, nurses, medical laboratory technicians, and the like.

Various phases of samples, such as fluids, solids, and the like, may be inspected by the inspection apparatus. Inspection of a fluid sample will be described below.

Inspection of a fluid sample may be implemented to detect the presence and/or density of a target material in the sample. To this end, a specific reaction between materials may be used. Data showing an optical property (hereinafter referred to as optical property data) of a reaction product of the sample and a reagent including a material that specifically reacts with the target material may be acquired to detect the presence and/or density of the target material.

In this case, the optical property may be optical density, transmittance, luminance, i.e., fluorescence, reflectance, or the like. The optical property data may be information regarding variation of the optical property caused as reaction between the sample and the reagent progresses. More specifically, the optical property data may include information regarding variation of optical density, transmittance, luminance, i.e. fluorescence, reflectance, or the like.

Here, optical density, transmittance, and reflectance may be acquired by emitting light to a reaction product of the sample and the reagent. The light transmitted through or reflected by the reaction product may be detected, and may show the degree of absorption, transmission, or reflection of light emitted to the reaction product. Luminance, i.e., fluorescence, may be acquired by emitting light to the reaction product for a period of time and then stopping the emission of light, and measuring light from the reaction product after stopping emission of light. This may show the light emission degree of the reaction product. Luminance may also be referred to as fluorescence.

The inspection apparatus may measure the optical property for a given time during which the reaction product of the sample and the reagent is produced, and may calculate the density of the target material based on the optical property data acquired for the given time. Under an emergency situation, such as treatment of an emergency patient, however, it may be necessary to reduce a time taken to calculate the density of the target material. Hereinafter, the inspection apparatus, which may predict inspection results, will be described in detail with reference to the drawings.

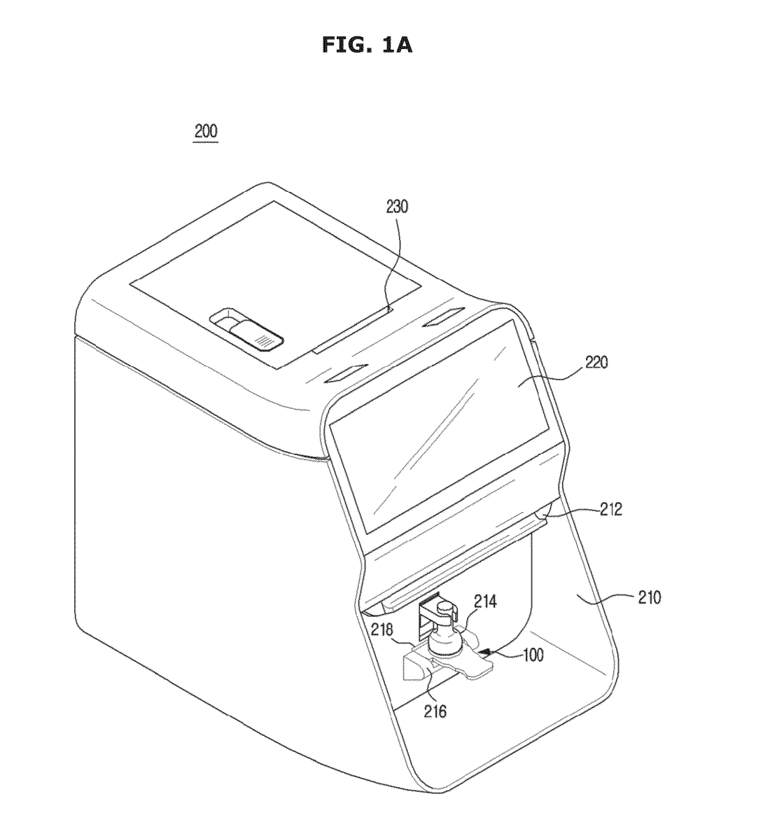

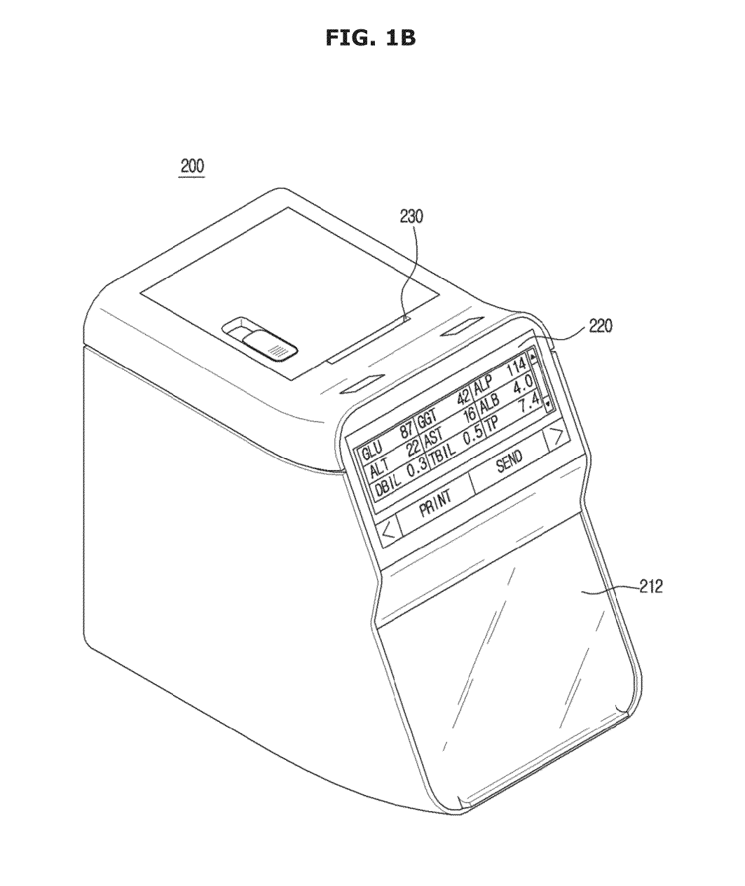

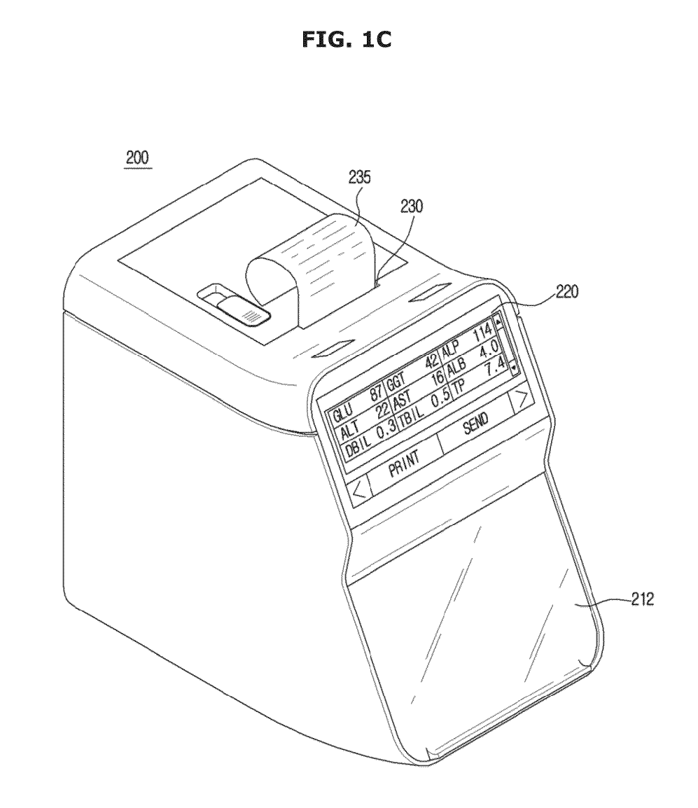

An external appearance and basic inspection operation of the inspection apparatus will be described below with reference to FIGS. 1A to 1C. FIGS. 1A to 1C are views showing an external appearance of the inspection apparatus in accordance with an exemplary embodiment.

Referring to FIG. 1A, the inspection apparatus, designated by reference numeral 200, may accurately detect the density of a target material present in a sample using only a small amount of the sample via a simplified inspection process. In this case, the kind of the sample and the kind of a reagent are not limited.

For example, when the sample is blood and the target material is an enzyme, the density of the enzyme in the blood may be detected by reacting a reagent, which includes a capture material having a specific reaction with the enzyme, with the blood.

Meanwhile, the inspection apparatus 200 may include a mounter 210, in which an analysis cartridge 100 is mounted. In this case, the sample may be introduced into the analysis cartridge 100, and reaction between the introduced sample and the reagent may occur in the analysis cartridge 100.

The inspection apparatus 200 may further include a display 220 to display inspection results or the progress of inspection, and printer 230 to print the inspection results. In this case, the display 220 may be a touchscreen, and may receive instructions from a user.

Meanwhile, door 210 may be slid open to mount the analysis cartridge 100 in the mounter 210. The analysis cartridge 100 may be inserted into the inspection apparatus 200 through an insertion slot 218 formed in the mounter 210.

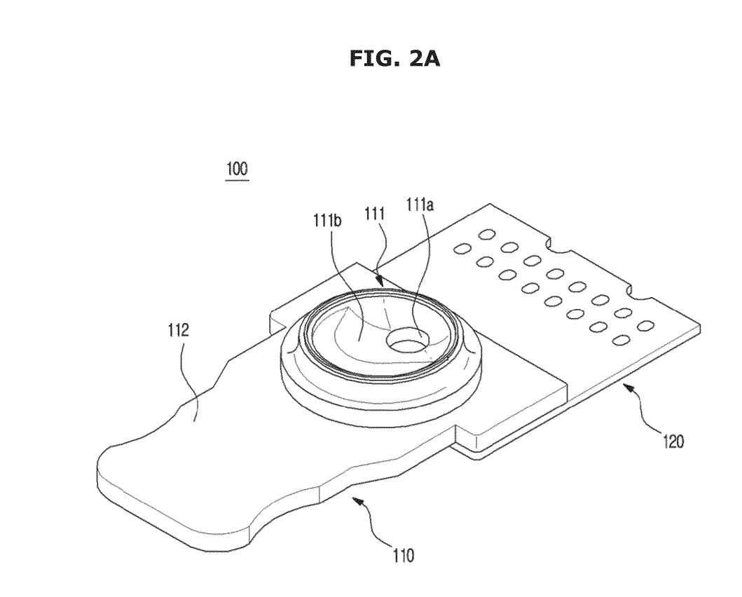

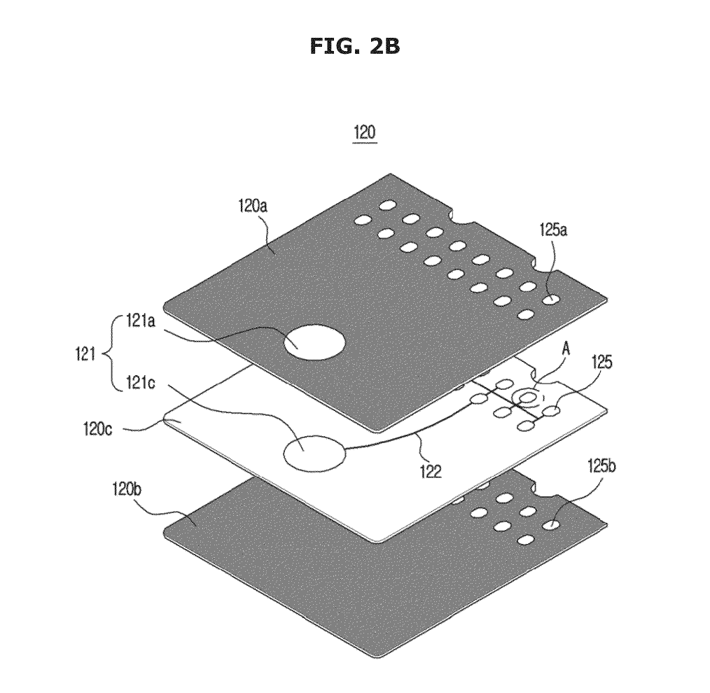

More particularly, a portion of the analysis cartridge 100 where the sample and the reagent react with each other (120 of FIG. 2A) may be inserted into the inspection apparatus 200 through the insertion slot 218, and the remaining portion of the analysis cartridge 100 may be exposed to the outside of the inspection apparatus 200 and be supported by a support prop 216.

A pusher 214 may apply pressure to the analysis cartridge 100. More specifically, the pusher 214 may apply pressure to the portion of the analysis cartridge 100 where the sample and the reagent react with each other, to facilitate introduction of the sample into the analysis cartridge 100.

Once the analysis cartridge 100 has been completely mounted, as exemplarily shown in FIG. 1B, the door 212 may be closed to begin inspection. More specifically, the inspection apparatus 200 may emit light to the reaction product of the sample and the reagent, and calculate optical property data by monitoring variation of an optical property as the reaction progresses. A detailed description related to this will be described below.

After completion of inspection, inspection results are displayed on the display 220. In this case, the analysis cartridge 100 may detect a plurality of target materials, and thus inspection results with regard to the respective target materials may be displayed on the display 220. In addition, the inspection results, as exemplarily shown in FIG. 1C, may be printed on material 235 via the printer 230.

A configuration as exemplarily shown in FIGS. 1A to 1C is given as an exemplary embodiment. The external appearance and configuration of the inspection apparatus may be realized in various ways.

Hereinafter, the analysis cartridge will be described in detail with reference to FIGS. 2A and 2B.

FIG. 2A is a view showing an external appearance of the analysis cartridge in accordance with an exemplary embodiment of the analysis cartridge for use in the inspection apparatus 200 shown in FIGS. 1A to 1C.

Referring to FIG. 2A, the analysis cartridge 100 includes a housing 110 and an inspection portion 120 where the sample and the reagent react with each other.

The housing 110 includes a grip portion 112, which serves not only to support the inspection portion 120, but also to assist the user in gripping the analysis cartridge 100. The housing 110 may be supported by the support prop (216 of FIG. 1A).

In this case, the grip portion 112 may take the form of a streamlined protrusion to assist the user in stably gripping the analysis cartridge 100 without touching the inspection portion 120 or a feed portion 111.

The housing 110 may include the feed portion 111 to which the sample is fed. In this case, a fluid to be inspected by the inspection apparatus 200 may be fed through the feed portion 111. For example, a bio sample, such as blood, bodily fluid, such as tissue fluid and lymph fluid, salvia, urine, etc., or an environmental sample for water-purity management or soil management may be fed through the feed portion 111.

More specifically, the feed portion 111, as exemplarily shown in FIG. 2A, may include a feedhole 111a, through which the fed sample is introduced into the inspection portion 120, and a feed assistance portion 111b to assist feed of a fluid.

With the above described configuration, the user may easily feed the sample into the analysis cartridge 100 by dropping the sample into the feedhole 111a using a tool, such as a pipette or dropper, or other similar tools. The feedhole 111a may be pressurized by the pusher (214 of FIG. 1A), which facilitates introduction of the sample into the inspection portion 120.

The feed assistance portion 111b is formed around the feedhole 111a so as to be inclined toward the feedhole 111a, and assists the sample dropped around the feedhole 111a in flowing into the feedhole 111a.

The housing 110 may be formed of a chemically and biologically inactive material that may be easily molded. For example, the housing 110 may be formed of various materials, such as plastic materials including acryl, such as polymethylmethacrylate (PMMA), etc., polysiloxane, such as polydimethylsiloxane (PDMS), etc., polycarbonate (PC), polyethylene, such as linear low-density polyethylene (LLDPE), low-density polyethylene (LDPE), medium-density polyethylene (MDPE), high-density polyethylene (HDPE), etc., polyvinyl alcohol, very low density polyethylene (VLDPE), polypropylene (PP), acrylonitrile butadiene styrene (ABS), cycloolefin copolymer (COC), etc., glass, mica, silica, semiconductor wafer, and the like.

The inspection portion 120 may be coupled to the housing 110. More specifically, the inspection portion 120 may be bonded to a portion of the housing 110 below the feed portion 111 using an adhesive, or may be fitted into a groove formed in the housing 110.

A Pressure Sensitive Adhesive (PSA) is one example of an adhesive used to bond the housing 110 and the inspection portion 120 to each other. A PSA achieves adhesion of an object within a short time upon receiving a low pressure equal to a finger pressure at room temperature, does not cause cohesion breakage during peeling, and does not leave behind a residue on a surface of the object.

Meanwhile, the sample, fed through the feedhole 111a, is introduced into the inspection portion 120. In this case, the sample may be filtered by a filter inside the feedhole 111a prior to being introduced into the inspection portion 120.

For example, when the sample is blood, the sample, which has been fed through the feedhole 111a, may be filtered such that blood cells are caught and only blood plasma or serum is introduced into a feed path 122 of the inspection portion 120.

Here, the filter may include a polymer membrane formed of polycarbonate (PC), polyethersulfone (PES), polyethylene (PE), polysulfone (PS), polyacrylsulfone (PASF), or the like, and the polymer membrane may be porous for filtration of the sample.

FIG. 2B is an exploded view showing a configuration of the inspection portion of the analysis cartridge shown in FIG. 2A.

Referring to FIG. 2B, the inspection portion 120 of the analysis cartridge 100 may be formed by bonding three plates 120a, 120b, 120c to one another. The three plates may include an upper plate 120a, a lower plate 120b, and an intermediate plate 120c. The upper plate 120a and the lower plate 120b may be printed with a light shielding ink, and protect the sample that flows into an inspection chamber 125 from external light, or to prevent an error with regard to measurement of an optical property in the inspection chamber 125.

The upper plate 120a and the lower plate 120b may take the form of films. The films, used to form the upper plate 120a and the lower plate 120b, may be one selected from among a polyethylene film, such as a very low-density polyethylene (VLDPE) film, linear low density polyethylene (LLDPE) film, low-density polyethylene (LDPE) film, medium-density polyethylene (MDPE) film, high-density polyethylene (HDPE) film, etc., a polypropylene (PP) film, a polyvinylchloride (PVC) film, polyvinyl alcohol (PVA) film, polystyrene (PS) film, and a polyethylene terephthalate (PET) film.

The intermediate plate 120c of the inspection portion 120 may be a porous sheet, such as a cellulose sheet. Thus, the intermediate plate 120c may serve as a vent. The porous sheet may be formed of a hydrophobic material, or may be subjected to hydrophobic treatment, thus having no effect on movement of the sample.

A microfluidic structure, basically provided in the inspection portion 120, may include an entrance 121, into which the sample having passed through the filter is introduced, the feed path 122 for movement of the introduced sample, and the inspection chamber 125 in which reaction between the sample and the reagent occurs.

As exemplarily shown in FIG. 2B, when the inspection portion 120 has a triple-layered structure, the upper plate 120 may have an entrance 121a for introduction of the sample, and a portion 125a of the inspection portion 120 corresponding to the inspection chamber 125 may be transparent. The entrance 121a may be exposed to the outside, and the portion 125a corresponding to the chamber 125 may be a transparent portion.

A portion 125b of the lower plate 120b corresponding to the inspection chamber 125 may be transparent. Providing the transparent portions 125a, 125b corresponding to the inspection chamber 125 enables measurement of an optical property with regard to reaction occurring in the inspection chamber 125.

The microfluidic structure of the inspection portion 120 is substantially defined by the intermediate plate 120c. More specifically, the intermediate plate 120c has an entrance 121c for introduction of the sample. When the upper plate 120a, the intermediate plate 120c, and the lower plate 120b are bonded to each other, the entrance 121a of the upper plate 120a and the entrance 121c of the intermediate plate 120c overlap each other, defining the entrance 121 of the inspection portion 120.

The inspection chamber 125 is formed at a region of the intermediate plate 120c opposite to the entrance 121c. The inspection chamber 125 may be formed by removing a given region, such as a circular region, a rectangular region, or the like, corresponding to the inspection chamber 125 from the intermediate plate 120c. Since the portions 125a, 125b of the upper plate 120a and the lower plate 120b corresponding to the inspection chamber 125 are not exposed to the outside, the inspection chamber 125 in which the sample and the reagent may be received may be defined by removing a given region of the intermediate plate 120c. Alternatively, a microfluidic storage container may be disposed in a removed region of the intermediate plate 120c, and serve as the inspection chamber 125.

As exemplarily shown in FIGS. 2A and 2B, the apparatus may include a plurality of inspection chambers 125, and different kinds of reagents may be received in the respective inspection chambers 125, such that various target materials may be detected using one analysis cartridge 100.

For example, when the sample is blood, a reagent including a capture material that specifically reacts with a target material in the blood is previously received in each inspection chamber 125. In this case, when the blood is introduced into the inspection chamber 125, an optical property may be detected from a specific reaction between the capture material of the previously received reagent and the target material, enabling detection of the presence of the target material or the density of the target material

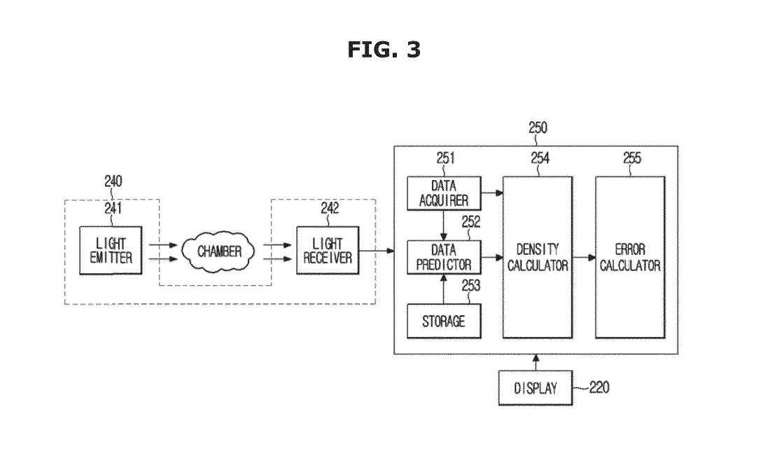

FIG. 3 is a control block diagram of the inspection apparatus in accordance with an exemplary embodiment.

Referring to FIG. 3, the inspection apparatus 200 may include a detector 240 to detect an optical signal from the inspection chamber 125 by emitting light to the inspection chamber 125, a display 220 to provide the user with information, and a controller 250 to control general operation of the inspection apparatus 200. Hereinafter, the detector 240 will be described in detail with reference to FIGS. 3 to 5.

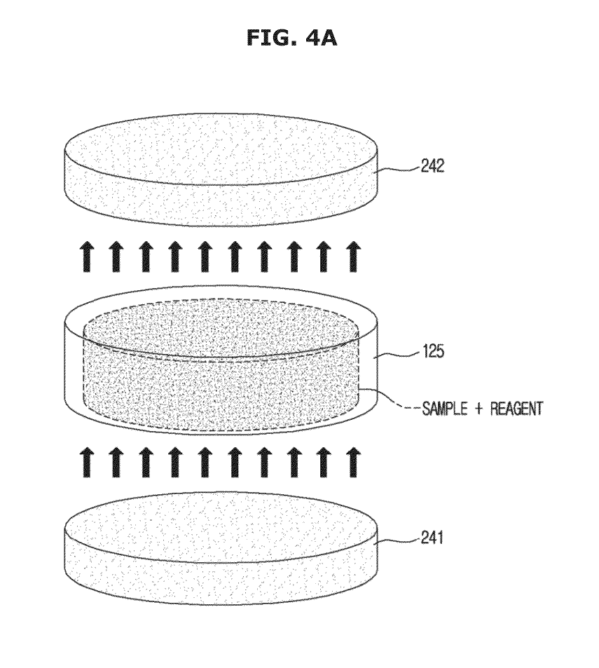

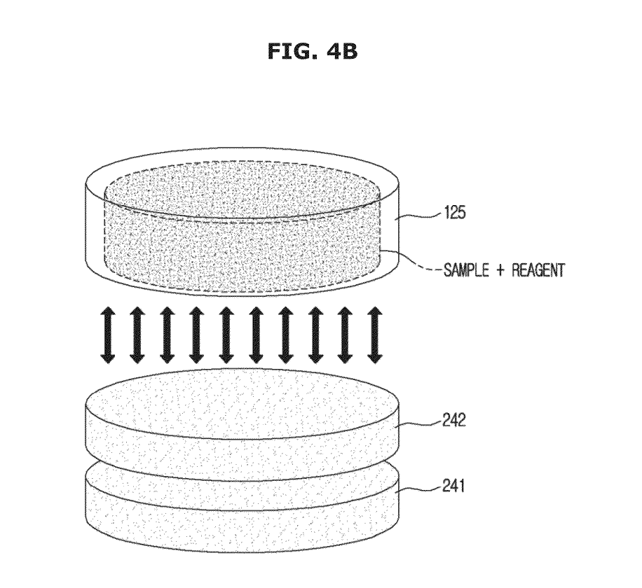

FIG. 4A is a view schematically showing the detector corresponding to the inspection chamber 125 of FIG. 2B.

The display 220 may provide the user with various information related to the inspection apparatus 200. For example, the display 220 may provide the user with information such as settings of the inspection apparatus 200, the progress of inspection, inspection results, etc.

The display 220 may be a Liquid Crystal Display (LCD), a Light Emitting Diode (LED) display, an Organic Light Emitting Diode (OLED) display, an Active Matrix Organic Light Emitting Diode (AMOLED) display, a flexible display, a 3-dimensional (3D) display, or the like.

The display 220 may be a touchscreen and receive an instruction from the user. Hereinafter, for convenience of description, the display 220 of the inspection apparatus 200 will be described as a touchscreen.

The detector 240 may include a light emitter 241 to emit light to the inspection chamber 125, and a light receiver 242 to detect light from the inspection chamber 125.

The light emitter 241 may emit light having a predetermined wavelength to the inspection chamber 125. More specifically, the light emitter 241 may emit light having a main wavelength to the inspection chamber 125. Here, light having the main wavelength refers to light having a wavelength, an optical property that sensitively changes by the reaction product of the sample and the reagent, and is a reference for calculation of the density of the target material. This will be described below in detail.

The light emitter 241 may emit light having a sub wavelength to the inspection chamber 125. Here, light having a sub wavelength refers to light having a constant optical property regardless of the reaction product of the sample and the reagent, and may be used to eliminate noise generated during inspection.

The main wavelength and the sub wavelength as described above may be different per inspection item. In this case, the inspection item refers to the target material of the sample to be detected. Provision of different reagents per target material causes different reaction products of the target material and the reagent.

In turn, the different reaction products per inspection item may cause different main wavelengths and different sub wavelengths per inspection item. Thus, the main wavelength and the sub wavelength may be determined based on experiments, statistics, theories, or the like.

The light emitter 241 may be a light source to flick on and off at a predetermined wavelength, for example, any one of a semiconductor light emitter, such as a Light Emitting Diode (LED) or Laser Diode (LD), or a gas discharge lamp, such as a halogen lamp or xenon lamp.

In addition, the light emitter 241 may be a planar light source having a great light emission area to uniformly emit light over a constant area of the analysis cartridge 100. For example, the light emitter 241 may be a backlight.

The light receiver 242 may detect light introduced into the inspection chamber 125. More specifically, the light receiver 242 may detect light having a main wavelength introduced from the inspection chamber 125, and output a main wavelength signal corresponding to the intensity of light having the detected main wavelength. In this case, the main wavelength signal may be an electrical signal.

The light receiver 242 may detect light having a sub wavelength introduced from the inspection chamber 125, and output a sub wavelength signal corresponding to the intensity of light having the detected sub wavelength. In this case, the sub wavelength signal may be an electrical signal.

The light receiver 242 may detect light at one or multiple predetermined time intervals, and output an electrical signal corresponding to the intensity of the detected light at the predetermined time intervals.

The light receiver 242 may include a plurality of pixels to detect light on a per pixel basis and to output an electrical signal corresponding to the intensity of the detected light at each pixel. For example, the light receiver 242 exemplarily shown in FIG. 4A may have 9 pixels corresponding to one inspection chamber 125.

Light introduced into the light receiver 242 may be light transmitted through the inspection chamber 125, light reflected by the inspection chamber 125, or light emitted from the reaction product.

For example, the light emitter 241 and the light receiver 242, as exemplarily shown in FIG. 4A, may be opposite to each other with the inspection chamber 125 interposed therebetween. In this case, the light receiver 242 may detect light transmitted through the inspection chamber 125 and output an electrical signal corresponding to the intensity of the detected light.

In addition, both the light emitter 241 and the light receiver 242 may be arranged above or below the inspection chamber 125, as exemplarily shown in FIG. 4B. In this case, the light receiver 242 may detect light reflected by the inspection chamber 125, and output an electrical signal corresponding to the intensity of the detected light.

As exemplarily shown in FIG. 2B, the analysis cartridge 100 may include the plural inspection chambers 125, and the respective inspection chambers 125 may be used for inspection of different inspection items.

Accordingly, the light emitter 241 may emit light having different wavelengths to the respective inspection chambers 125 to enable simultaneous inspection of plural inspection items.

The controller 250 may acquire optical property data by controlling the general inspection apparatus 200, and calculate inspection results based on the acquired optical property data.

To this end, the detector 240 may be controlled by the controller 250 so as to emit light having a predetermined wavelength to the inspection chamber 125 and detect light from the inspection chamber 125.

The controller 250 may include one or more processors. The processors may be an array of plural logic gates, or may be a combination of a universal microprocessor and a memory in which a program to be executed by the microprocessor is stored. Naturally, those skilled in the art will understand that the controller may be other types of hardware.

The controller 250 may include a data acquirer 251. The data acquirer 251 may acquire optical property data based on a signal output from the detector 240.

More specifically, the data acquirer 251 may calculate optical property data regarding light having a main wavelength based on a main wavelength signal output from the detector 240. The optical property data may include information regarding optical property variation depending on time.

In addition, the data acquirer 251 may eliminate noise based on a sub wavelength signal output from the detector 240. Light having a sub wavelength has no optical property variation despite reaction of the sample and the reagent as described above. Thus, optical property data, from which noise is removed, may be produced based on the main wavelength signal and the sub wavelength signal. This will be described below in detail.

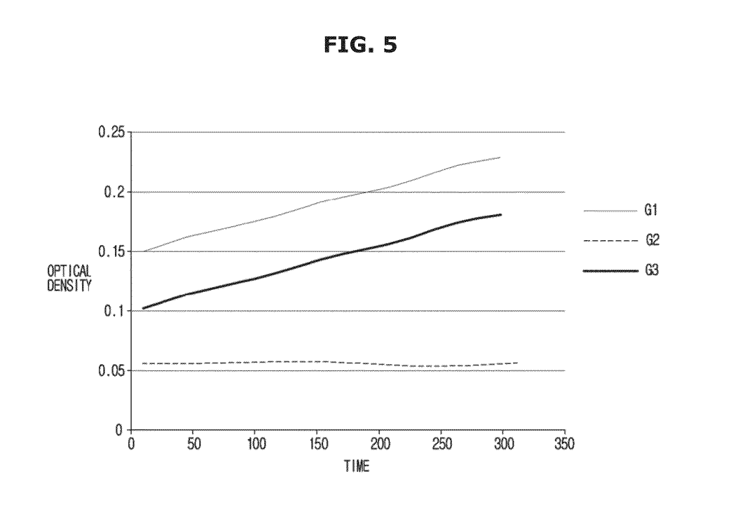

Hereinafter, one example with regard to acquisition of optical property data will be described below with reference to FIG. 5.

FIG. 5 is a graph showing one example of optical property data. FIG. 5 illustrates acquisition of optical property data with regard to a Gamma Glutamyl Transferase (GGT) inspection item as one metric of liver function. The abscissa, or x-axis, of FIG. 5 represents time and the ordinate, or y-axis, of FIG. 5 represents optical density.

In the graph, line G1 shows optical density variation of light having a main wavelength, line G2 shows optical density variation of light having a sub wavelength, and line G3 shows optical property data acquired by the data acquirer 251.

The data acquirer 251 may acquire optical density variation G1 of light having a main wavelength based on a main wavelength signal output from the detector 240, and acquire optical density variation G2 of light having a sub wavelength based on a sub wavelength signal output from the detector 240.

As will be appreciated from the line G1, optical density of light having a main wavelength gradually increases as reaction progresses, and therefore the line G1 may be a reference for calculation of the density of the target material.

As will be appreciated from the line G2, optical density of light having a sub wavelength has a substantially constant value even if reaction progresses. Thus, noise generated during inspection may be eliminated based on optical density of light having a sub wavelength.

Accordingly, the data acquirer 251 may acquire optical property data G3 by subtracting optical density of light having a sub wavelength from optical density of light having a main wavelength.

The controller 250 may further include a data predictor 252. The data predictor 252 may predict optical property data after a predetermined time using optical property data acquired for a predetermined time even if inspection does not end.

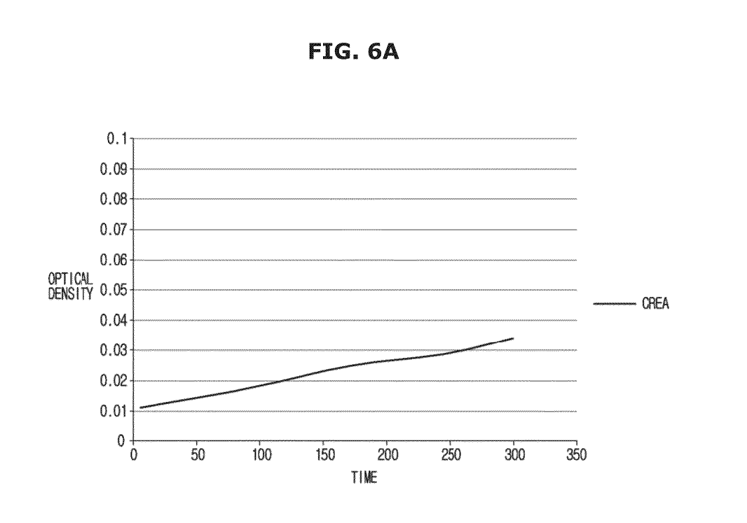

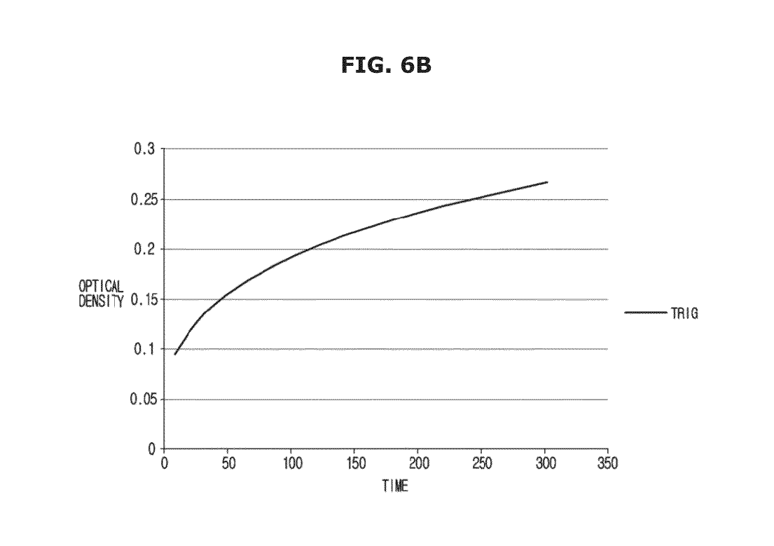

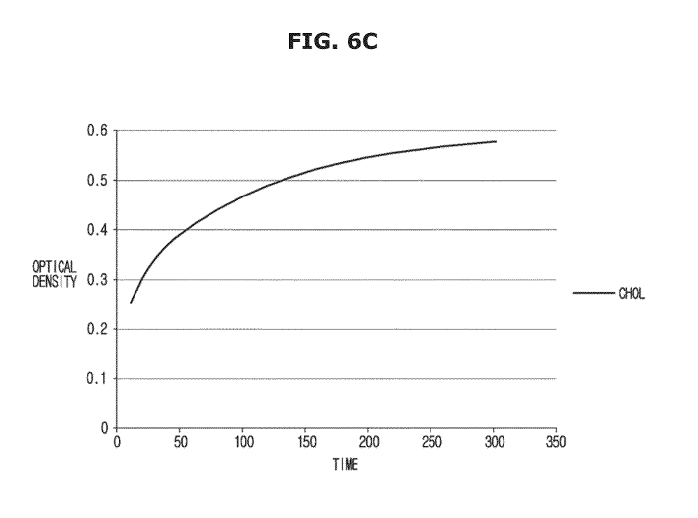

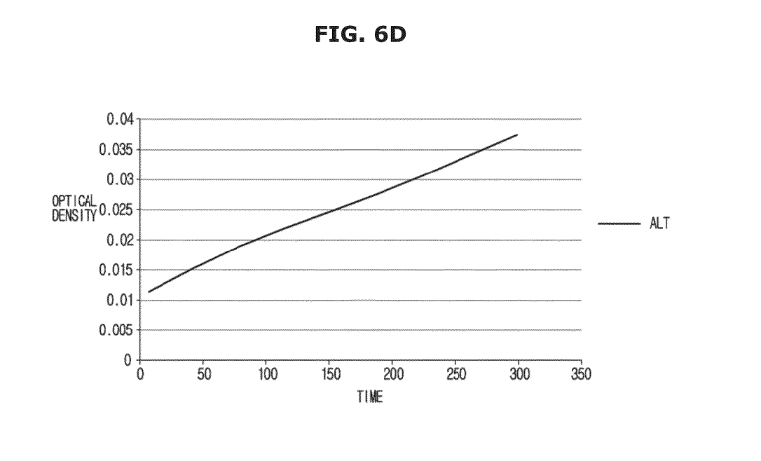

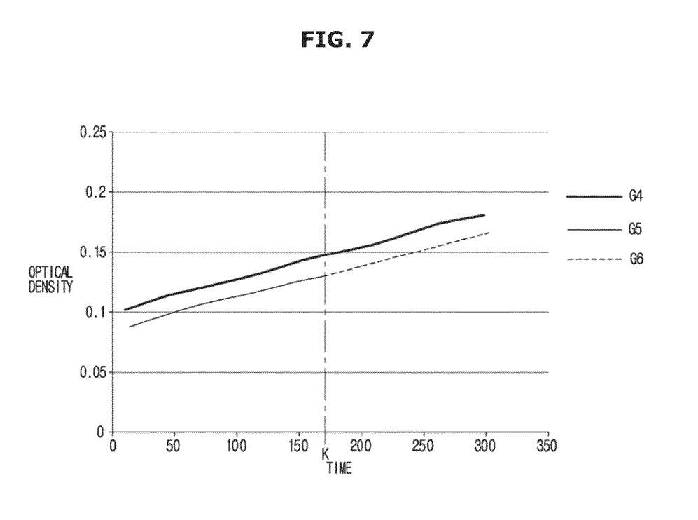

FIGS. 6A to 6D are graphs showing a pattern of optical property data per inspection item. FIG. 7 is a graph showing prediction of optical property data.

In general, optical property data with regard to the same inspection item may have similar patterns. Thus, optical property data after a reference point in time may be predicted using optical property data acquired before the reference point in time and general optical data regarding an inspection item.

Here, the reference point in time may be set by the user, or may be predetermined. In addition, the reference point in time may be a point in time when the user inputs a result prediction instruction as will be described below.

Optical property data may have different patterns per inspection item. For example, optical property data may have linear, log, exponential, and polynomial patterns per inspection item. In other words, the degree of reaction between the sample and the reagent may be different per inspection item, and thus optical property data may have different patterns per inspection item.

For example, optical property data may have a log pattern upon Creatine (CREA) inspection as exemplarily shown in FIG. 6A, may have a log pattern upon Triglyceride (TRIG) inspection as exemplarily shown in FIG. 6B, may have a log pattern upon Cholesterol (CHOL) inspection as exemplarily shown in FIG. 6C, and may have a linear pattern upon Alkaline Phosphatase (ALT) inspection as exemplarily shown in FIG. 6D.

Thus, the data predictor 252 may predict optical property data after a reference point in time using optical property data acquired before a predetermined point in time and a pattern of optical property data corresponding to each inspection item.

For example, assuming that general optical property data with regard to GGT inspection has a linear pattern as represented by line G4 in FIG. 7, each optical property data with regard to GGT inspection may be predicted as having variation only in terms of the gradient and optical density at the beginning.

Thus, optical density after a predetermined time K may be predicted as increasing by a gradient similar to the average gradient of optical property data G5 acquired for the predetermined time K. Accordingly, the data predictor 252 may produce optical property data G6 before an inspection end time by predicting that optical property will increase after the predetermined time K has passed based on the gradient calculated for the predetermined time K.

In addition, the data predictor 252 may apply different prediction methods based on a pattern of optical property data. For example, when optical property data has a log pattern, the data predictor 252 may calculate a log coefficient in a Minimum Mean Square Error (MMSE) manner, and predict optical property data, i.e. inspection results until an inspection end time after a predetermined time has passed based on the calculated log coefficient.

Meanwhile, the data predictor 252 may implement prediction of optical property data after optical property data is acquired before a predetermined critical point in time. In this case, the critical point in time may be input by the user, or may be predetermined.

In a concrete example, when an inspection end time is 300 seconds and a critical point in time is set to a point in time when 100 seconds have passed after inspection begins, the data predictor 252 may acquire optical property data for 100 seconds after inspection begins, and may predict inspection results using the optical property data acquired for 100 seconds.

Since prediction of optical property data is implemented after optical property data is acquired until a critical point in time, the inspection apparatus 200 may produce prediction results having at least a minimum accuracy level.

In addition, the inspection apparatus 200 may provide the user with inspection results within a reduced time by predicting optical property data and calculating the density of the target material based on the predicted optical property data regardless of the end of inspection. Accordingly, the inspection apparatus 200 enables rapid decision making of a medical team under an emergency situation, such as in the operating room, ambulance, etc.

Meanwhile, the inspection apparatus 200, as exemplarily shown in FIGS. 2A and 2B, may include the plural inspection chambers 125. In this case, the respective chambers may receive different reagents to enable simultaneously implementation of inspection with regard to various inspection items.

For example, the inspection chambers 125 may respectively receive a GGT inspection reagent, a CREA inspection reagent, a TRIG inspection reagent, a CHOL inspection reagent, and an ALT inspection reagent to simultaneously implement GGT inspection, CREA inspection, TRIG inspection, CHOL inspection, and ALT inspection.

Accordingly, the data predictor 252 may search a storage 253 for a pattern of optical property data corresponding to each inspection item, and predict optical property data based on the searched pattern of optical property data.

The controller 250 may further include the storage 253. In this case, the storage 253 may store various pieces of information necessary to control the inspection apparatus 200. In particular, the storage 253 may store patterns of optical property data with regard to respective inspection items.

The patterns of optical property data stored in the storage 253 may be previously stored by the user or may be produced by optical property data acquired by the data acquirer 251 after each inspection.

One or more optical property data acquired by the data acquirer 251 may be stored and a pattern of optical property data may be determined based on an average value of the stored optical property data.

The controller 250 may further include a density calculator 254. The density calculator 254 may detect the density of the target material included in the sample based on optical property data. For example, the density calculator 254 may calculate the density of the target material based on the variation degree of optical property, or may calculate the density of the target material based on total variation of an optical property.

In addition, the density calculator 254 may select a section of optical property data and calculate the density of the target material based on average variation or total variation of an optical property in the selected section.

The controller 250 may further include an error calculator 555. The error calculator 255 may calculate an error between final inspection results, based on optical property data acquired by the data acquirer 252 before an inspection end time, and a predicted inspection results based on optical property data predicted by the data predictor 252.

To this end, the data acquirer 251 may continuously acquire optical property data until an inspection end time.

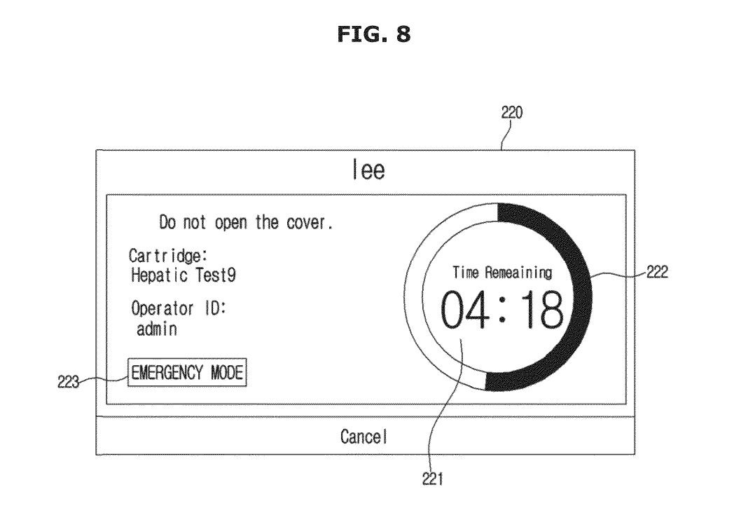

Meanwhile, the controller 250 may display the predicted inspection results and the final inspection results to the user. Hereinafter, an interface that may be displayed on the display 220 will be described in detail with reference to FIGS. 8 to 11.

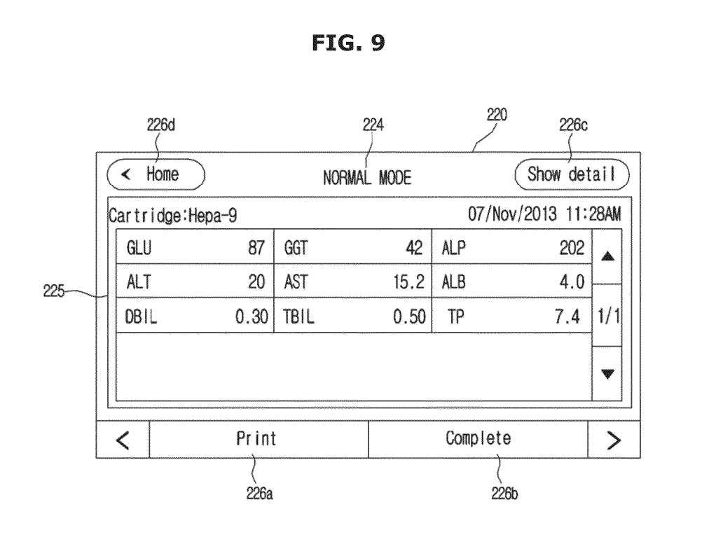

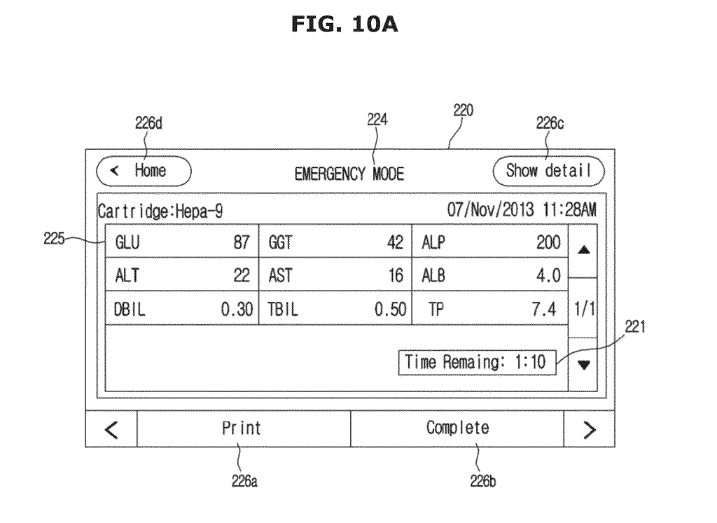

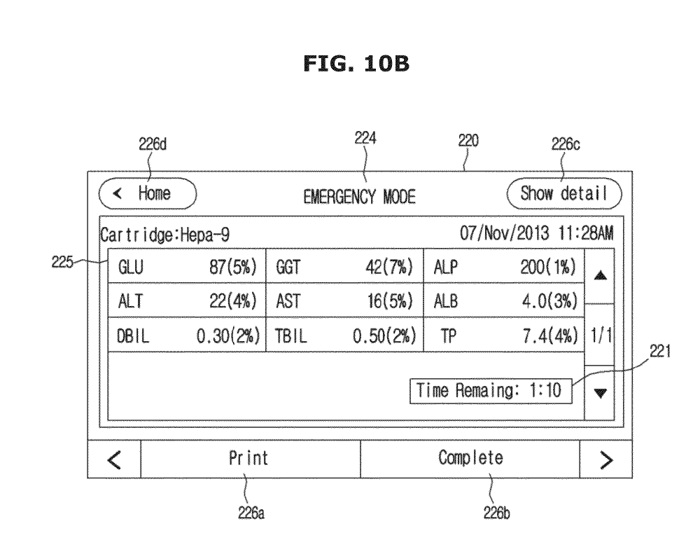

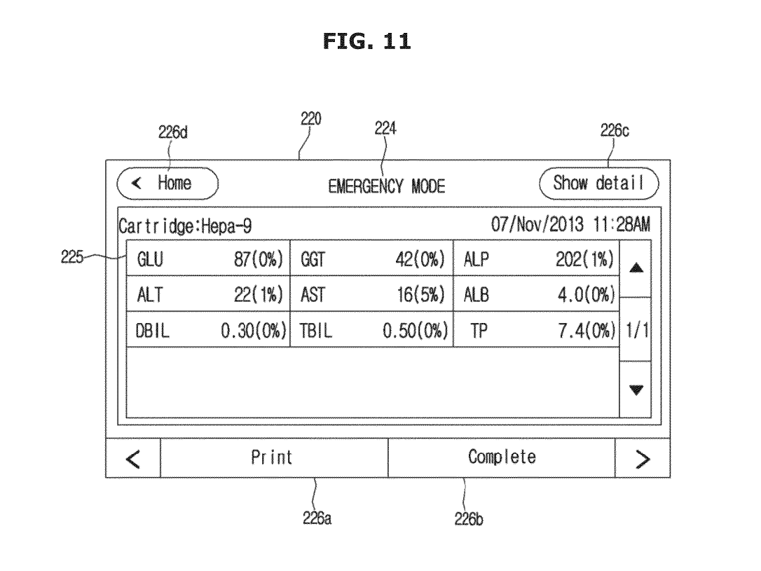

FIG. 8 is a view showing one example of an interface to display the progress of inspection. FIG. 9 is a view showing one example of an interface to display final inspection results. FIGS. 10A and 10B are views showing one example of an interface to display the progress of inspection. FIG. 11 is a view showing one example of an interface to display an inspection result error.

The display 220 may display information regarding inspection as the inspection progresses. For example, as exemplarily shown in FIG. 8, the display 220 may display information about warnings and settings related to the inspection (e.g., operator ID, and the type of the analysis cartridge 100).

The display 220 may further display a timer 221 that indicates a time remaining until the inspection ends, and a progress indicator 222 that indicates the progress of inspection for user convenience. In this case, the progress indicator 222 may indicate the progress rate of inspection.

In addition, an emergency mode button 223 may be displayed on the display 220 to receive an inspection result prediction instruction. In this case, when the emergency mode button 223 is selected by the user, the controller 250 predicts inspection results, and displays the predicted inspection results on the display 220.

When the emergency mode button 223 is selected, the data predictor 252 may predict optical property data after a reference point in time based on optical property data acquired before the reference point in time and a pattern of optical property data stored in the storage 253. The density calculator 254 calculates the density of the target material based on the predicted optical property data, and the display 220 displays finally predicted inspection results.

Alternatively, the reference point in time may be a point in time when the emergency mode button 223 is selected by the user. In this case, the controller 250 may predict inspection results based on optical property data acquired before the emergency mode button 223 is selected.

When the emergency mode button 223 is selected is earlier than a critical point in time, the controller 250 may acquire optical property data until the critical point in time, and predict inspection results based on the optical property data acquired before the critical point in time.

After inspection ends, the touchscreen may display final inspection results on a result display region 225 as exemplarily shown in FIG. 9. In this case, words to indicate that the displayed results are final inspection results (e.g., “Normal Mode”) may be displayed in an upper end region 224 of the display 220, and the density calculated by the density calculator 254 may be displayed on the result display region 225.

In this case, when different inspection items are provided in the respective inspection chambers 125 as exemplarily shown in FIGS. 2A and 2B, the density corresponding to each inspection item may be displayed in the result display region 225.

The display 220, as exemplarily shown in FIG. 10A, may display predicted inspection results in the result display region 225. In this case, words to indicate that the displayed results are predicted inspection results (e.g., “Emergency Mode”) may be displayed in the upper end region 224 of the display 220, and the density calculated based on the optical property data predicted by the data predictor 252 may be displayed in the result display region 225.

In this case, when different inspection items are provided in the respective inspection chambers 125 are provided as exemplarily shown in FIGS. 2A and 2B, the density corresponding to each inspection item may be displayed in the result display region 225.

The timer 221 may be displayed in a region of the display 220 to indicate a time remaining until inspection ends.

In addition, a first button 226a to receive a print instruction of predicted inspection results, a second button to receive an inspection completion instruction, a third button 226c to receive a display instruction of detailed inspection results, and a fourth button 226d to receive a home instruction to return to a home screen, may be displayed.

In addition, the display 220, as exemplarily shown in FIG. 10B, may display an error percent of the predicted inspection results as well as the predicted inspection results. In this case, the error percent may be experimentally accumulated data.

When inspection normally ends after display of the predicted inspection results, the touchscreen may display final inspection results in the result display region 225 as exemplarily shown in FIG. 11.

In this case, the display 220 may display an error percent calculated by the error calculator 255 along with the final inspection results. Displaying both the final inspection results and the error percent after displaying the predicted inspection results may provide feedback with regard to the predicted inspection results.

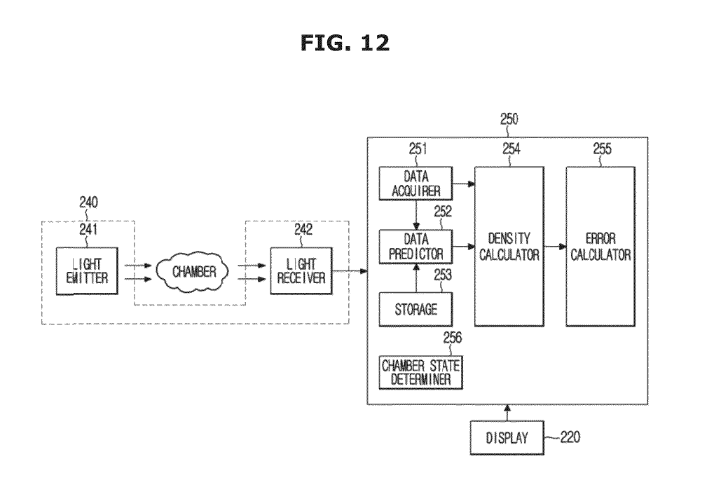

Hereinafter, the inspection apparatus 200 in accordance with an exemplary embodiment will be described in detail with reference to FIGS. 12 to 14. The same parts as those of the above described exemplary embodiment are designated by the same reference numerals and a detailed description thereof will be omitted below.

FIG. 12 is a control block diagram for detailed explanation of an inspection apparatus in accordance with an exemplary embodiment.

To acquire accurate inspection results, it may be necessary for normal operation for the sample and the reagent to remain in the inspection chamber 125 until inspection ends. That is, when the sample or the reagent does not remain in the inspection chamber 125 for some reason, appropriate collection of optical property data may be difficult.

Therefore, when an abnormal state occurs during monitoring of an inner state of the inspection chamber 125, in which the sample and the reagent do not remain in the inspection chamber 125 the inspection apparatus 200 in accordance with an exemplary embodiment may predict inspection results based on optical property data acquired before the abnormal state occurs.

Referring to FIG. 12, the inspection apparatus 200 may further include a chamber state determiner 256. Here, the chamber state determiner 256 determines whether the state of the inspection chamber 125 is in a normal state in which the sample and the reagent are normally received in the inspection chamber 125 or in an abnormal state in which the sample and the reagent are abnormally received.

The normal state may refer to a state in which appropriate amounts of sample and reagent are uniformly distributed in the inspection chamber, and the abnormal state may refer to a state where the sample and reagent are not uniformly distributed.

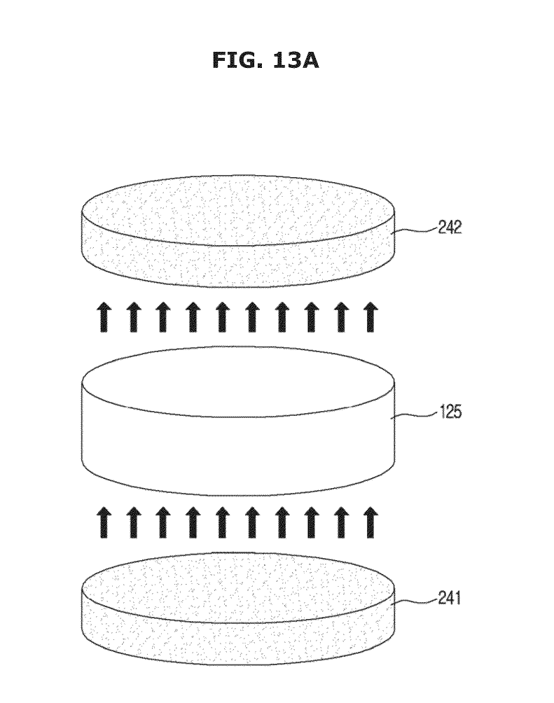

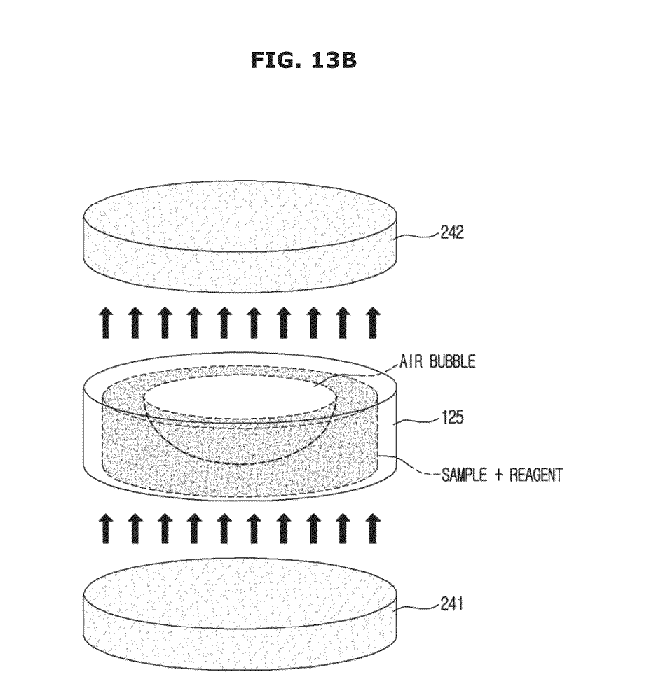

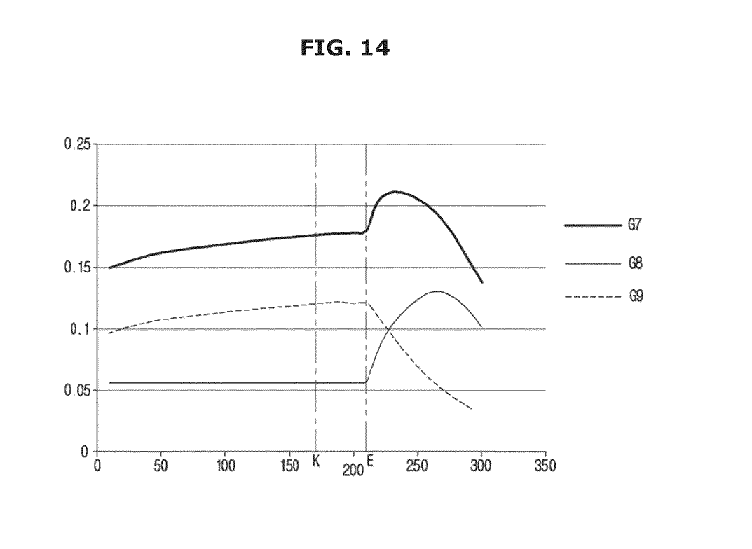

FIGS. 13A and 13B are views showing an abnormal state. FIG. 14 is a view showing an example of optical property variation when an abnormal state occurs in the inspection chamber.

To ensure that the inspection apparatus 200 achieves accurate inspection results, as exemplarily shown in FIG. 4A, it may be necessary to uniformly distribute appropriate amounts of sample and reagent in the inspection chamber 125. That is, the inspection apparatus 200 may achieve accurate inspection results only when the interior of the inspection chamber 125 maintains a normal state.

However, the sample and the reagent may cause an abnormal state in the inspection chamber 125 for various reasons. For example, even if a fluid is normally introduced into the inspection chamber 125 at the initial stage of inspection, an abnormal state may occur if the sample introduced into the inspection chamber 125 through the feed path 122 backflows to the feed path 122 during inspection, or if the sample overflows from the inspection chamber 125, or when air bubbles are generated in the inspection chamber 125 by air generated via reaction between the sample and the reagent.

More specifically, when an abnormal state occurs, where the sample or the reagent is not normally present in the inspection chamber 125, such when the sample is not present in the inspection chamber 125, as shown in FIG. 13A, or when air bubbles are present in a partial region of the inspection chamber 125, as shown in FIG. 13B, the inspection apparatus 200 might not achieve accurate inspection results.

That is, as exemplarily shown in FIG. 14, when an abnormal state occurs, a main wavelength signal and a sub wavelength signal detected by the detector 240 rapidly vary, and optical property data acquired based on the main wavelength signal and the sub wavelength signal do not provide the density of the target material. Thus, the inspection apparatus 200 achieves incorrect inspection results.

In particular, when the inspection apparatus 200 is used to diagnose a patient, the incorrect inspection results may cause erroneous diagnosis by a medical team. Thus, the inspection apparatus 200 may determine whether or not the sample and the reagent are normally received in the inspection chamber 125, and upon determining an abnormal state, may inform the user of occurrence of the abnormal state.

The chamber state determiner 256 determines whether or not the sample and the reagent are normally present in the inspection chamber 125. The chamber state determiner 256 may determine whether or not an abnormal state occurs based on an optical signal detected by the detector 240.

More specifically, in an abnormal state, a main wavelength signal (by which optical property varies via reaction of the sample and the reagent) and a sub wavelength signal (by which optical property does not vary despite reaction of the sample and the reagent) may rapidly vary.

Thus, the chamber state determiner 256 may determine the apparatus is in an abnormal state when an optical property of light having a main wavelength and an optical property of light having a sub wavelength rapidly, as exemplarily shown in FIG. 14.

More specifically, when an abnormal state occurs in the inspection chamber 125 as exemplarily shown in FIG. 13, at a point in time E (FIG. 14) during inspection of the inspection apparatus 200, an optical signal detected by the detector 240 rapidly varies. Thus, optical property data acquired by the data acquirer 251 rapidly varies as represented by line G9 in FIG. 14.

However, the chamber state determiner 256 may not necessarily determine that it is an abnormal state in the inspection chamber 125 based solely on an optical property variation G7 that indicates optical property variation of light having a main wavelength. On the other hand, the chamber state may determine that it is an abnormal state in the inspection chamber 125 based on optical property variation G8 that indicates optical property variation of light having a sub wavelength.

That is because optical property of light having a main wavelength sensitively varies based on the density of the target material, and therefore may rapidly vary even if an abnormal state does not occur in the inspection chamber 125. On the other hand, since optical property of light having a sub wavelength is constant regardless of the density of the target material, and rapidly varies only when an abnormal state occurs, the chamber state determiner 256 may determine whether or not an abnormal state occurs in the inspection chamber 125 based on optical property variation of light having a sub wavelength.

More specifically, when optical property of light having a sub wavelength deviates from a predetermined reference, the chamber state determiner 256 may determine occurrence of an abnormal state in the inspection chamber 125. For example, when a predetermined reference value of optical density is within a range of 0.04 to 0.07, the chamber state determiner 256 may determine occurrence of an abnormal state in the inspection chamber 125 at a point in time E when detected optical density of light having a sub wavelength exceeds 0.07, as exemplarily shown in FIG. 14.

In addition, the chamber state determiner 256 may determine occurrence of an abnormal state in the inspection chamber 125 when optical property of light having a sub wavelength varies beyond a critical value. To this end, the chamber state determiner 256 may differentiate optical property variation of light having a sub wavelength, and compare the resulting value with a critical value.

Upon determining occurrence of an abnormal state in the inspection chamber 125, the chamber state determiner 256 may inform the user of occurrence of the abnormal state. For example, occurrence of the abnormal state may be informed via the display 220.

The data predictor 252 may predict optical property data when the chamber state determiner 256 determines occurrence of an abnormal state in the inspection chamber 125. That is, a point in time when an abnormal state occurs may be the above described reference point in time.

Thus, the data predictor 252 may predict optical property data after the occurrence of an abnormal state in the inspection chamber 125 by using the optical property data acquired by the data acquirer 251 before the abnormal state occurred in the inspection chamber 125.

For example, optical property data may be predicted using optical property data G9 acquired during a duration from 0-E seconds before an abnormal state occurs in the inspection chamber 125 as exemplarily shown in FIG. 14.

More specifically, the data predictor 252 may search the storage 253 for a pattern of optical property data corresponding to an inspection item, and predict optical property data after an abnormal state occurs in the inspection chamber 125 by comparing the searched pattern of optical property data with optical property data acquired by the data acquirer 251 before occurrence of the abnormal state in the inspection chamber 125.

The density calculator 254 may calculate the density of the target material based on optical property data predicted by the data predictor 252, and display the calculated density of the target material on the display 220. In this case, occurrence of an abnormal state in the inspection chamber 125 may be displayed on the display 220.

As such, even if an abnormal state occurs in the inspection chamber 125, inspection results may be predicted based on optical property data acquired before occurrence of the abnormal state, which may reduce inspection time.

The inspection results may also be achieved without using the analysis cartridge 100, and recollection of the sample for additional inspection may be unnecessary.

Meanwhile, if the chamber state determiner 256 determines the occurrence of an abnormal state prior to a critical point in time, the data predictor 252 might not predict optical property data. The critical point in time may be determined by user settings or it may be predetermined.

As described above, as prediction of optical property data is not implemented when an abnormal state occurs in the inspection chamber 125 before a reference point in time, the inspection apparatus 200 may provide the user with predicted results ensuring at least a minimum accuracy level.

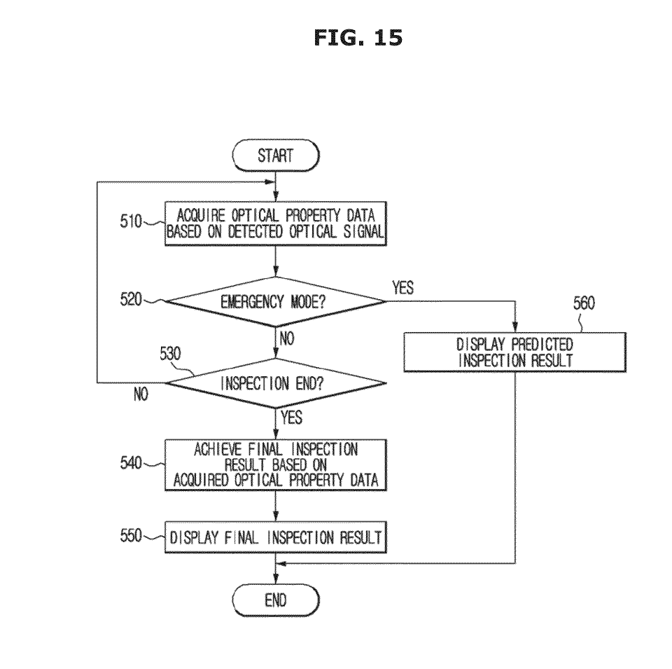

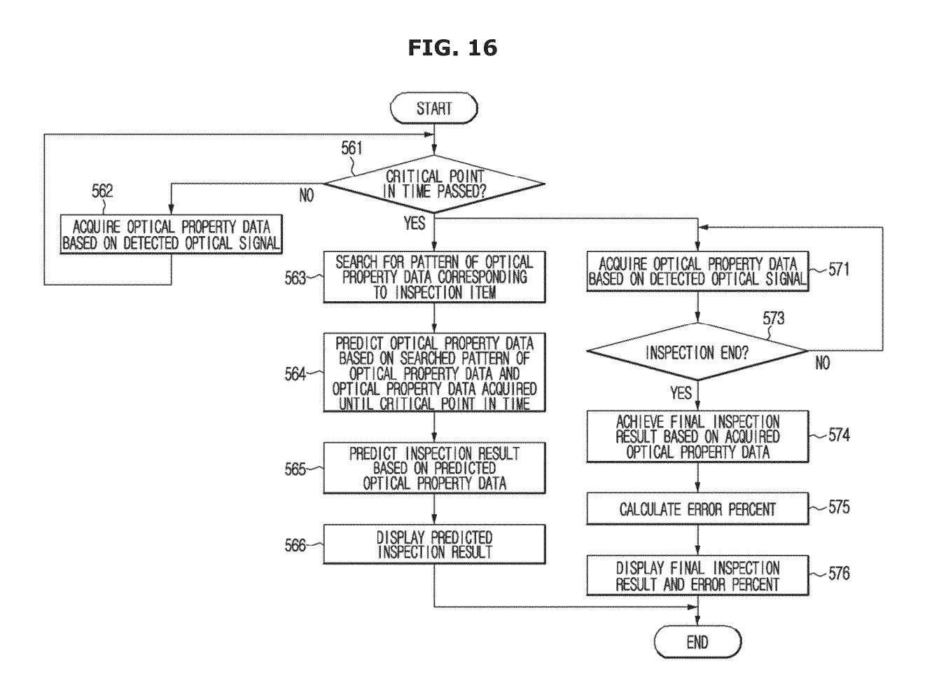

Hereinafter, an inspection method using the inspection apparatus will be described in detail with reference to FIGS. 15 and 16.

FIG. 15 is a flowchart showing an inspection method in accordance with an exemplary embodiment.

Referring to FIGS. 3 and 15, the controller 250 may acquire property data based on an optical signal detected by the detector 240 (510). More specifically, the controller 250 may acquire optical property variation of light having a main wavelength based on a main wavelength signal output from the detector 240, and produce optical property data based on the acquired optical property variation.

In addition, the controller 250 may acquire optical property variation of light having a sub wavelength based on a sub wavelength signal output from the detector 240, and remove noise from optical property data based on the acquired optical property variation.

The controller 250 determines whether or not an emergency mode occurs (520). Here, the emergency mode is a mode in which all optical property data is predicted based on optical property data acquired for a predetermined time, and predicted inspection results are calculated and displayed based on the predicted optical property data. The emergency mode may begin in response to user input. The predicted inspection results will be described below in detail.

When the emergency mode does not occur (No in 520), the controller 250 determines whether or not inspection ends (530). When inspection does not end (No in 530), the controller 250 repeatedly acquires optical property data based on a detected optical signal (510).

Upon determining the end of inspection (Yes in 530), the controller 250 achieves final inspection results based on the acquired optical property data (540). In this case, the final inspection results may be the density of the target material calculated based on optical property data acquired for a predetermined time until inspection ends.

The controller 250 may display the final inspection results on the display 220 (550).

On the other hand, when the emergency mode occurs (Yes in 520), the controller 250 achieves and displays predicted inspection results (560).

FIG. 16 is a flowchart for detailed explanation of 560 of FIG. 15.

Referring to FIGS. 3, 15 and 16, when the emergency mode begins, the controller 250 may determine whether or not a current point in time is later than a critical point in time (561). When the current point in time is earlier than the critical point in time (No in 561), the controller 250 continues to acquire optical property data based on a detected optical signal (562).

That is, even if the emergency mode begins, the controller 250 continues to acquire optical property data until the current point in time is later than the critical point in time (Yes in 561).

After acquiring optical property data until the critical point in time, as described above, the controller 250 may predict inspection results to provide the user with inspection results ensuring at least a minimum accuracy level. Meanwhile, the critical point in time may be set by the user or it may be predetermined.

When optical property data is acquired until the critical point in time (Yes in 561), the controller 250 may search for a pattern of optical property data corresponding to each inspection item (563). The pattern of optical property data may be determined using previously acquired optical property data, or may be determined by the user. For example, the pattern of optical property data may be one of a linear pattern, a log pattern, an exponential pattern, or a polynomial pattern.

Then, the controller 250 may predict optical property data until an inspection end time based on optical property data acquired before the critical point in time and the searched pattern of optical property data (564).

In this case, the controller 250 may use different prediction methods based on the pattern of optical property data. For example, when the pattern of optical property data is a linear pattern, the controller 250 may calculate the average gradient before the critical point in time, and predict optical property data after the critical point in time based on the calculated average gradient.

When the pattern of optical property data is a log pattern, the controller 250 may calculate a log coefficient for use in prediction in an MMSE manner, and predict optical property data after the critical point in time based on the calculated log coefficient.

The controller 250 may predict inspection results based on the predicted optical property data (565). In this case, the predicted inspection results may be calculated based on optical property data that is predicted from optical property data acquired before the critical point in time, and may include the density of a specific target material.

The predicted inspection results may be displayed to the user via the display 220 (566).

Meanwhile, as shown on the right side of FIG. 16, even when the critical point in time is reached (Yes in 561), the controller 250 may continue to acquire optical property data based on a detected optical signal until inspection ends (571).

When inspection ends (Yes in 573), the controller 250 may achieve final inspection results based on the acquired optical property data (574), and may calculate an error percent between the final inspection results based on substantially acquired optical property data and the inspection results predicted based on the predicted optical property data (575).

Then, the final inspection results and the error percent may be displayed on the display 220 (576). Displaying the predicted inspection results and thereafter displaying the final inspection results and the error percent may provide user convenience.

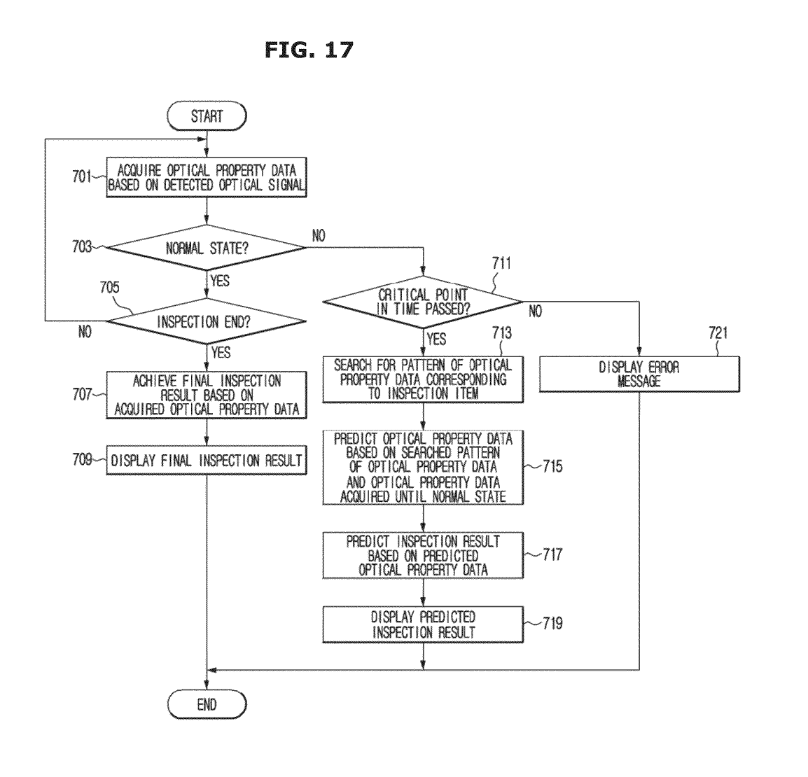

FIG. 17 is a flowchart explaining an inspection method in accordance with an exemplary embodiment.

Referring to FIG. 17, the controller 250 acquires optical property data based on an optical signal detected until inspection ends (701). In this case, optical property data may be acquired based on a main wavelength signal related to light having a main wavelength and a sub wavelength signal related to light having a sub wavelength.

In this case, the controller 250 may determine whether or not the chamber is in a normal state based on the detected optical signal (703). More specifically, the controller 250 may determine the state of the chamber by monitoring optical property variation of light having a sub wavelength based on the sub wavelength signal.

For example, the controller 250 may determine occurrence of an abnormal state in the inspection chamber 125 when optical property of light having a sub wavelength deviates from a reference value or varies beyond a critical value (No in 703).

When a normal state is continued until inspection ends (Yes in 705), the controller 250 may achieve final inspection results based on optical property data acquired before inspection ends (707), and display the achieved inspection results (709).

When an abnormal state occurs before inspection ends (No in 703), the controller 250 may determine whether or not a critical point in time has passed (711).

In this case, when abnormal state occurs after the critical point in time (Yes in 711), the controller 250 may search for a pattern of optical property data corresponding to each inspection item (713), and predict optical property data based on the searched pattern of optical property data and optical property data acquired before occurrence of the abnormal state.

The controller 250 predicts inspection results based on the predicted optical property data (717), and displays the predicted inspection results on the display 220 (719).

Meanwhile, when an abnormal state occurs before the critical point in time (No in 711), the controller 250 may notify the user of an inspection error, and end inspection (721).

As is apparent from the above description, an inspection apparatus may predict optical property data until an inspection end time based on optical property data acquired before a reference point in time, and provide inspection results based on the predicted optical property data, thereby providing a user with inspection results at an early stage.

Although exemplary embodiments of the present invention have been shown and described, those skilled in the art will readily appreciate that many modifications are possible in these exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. An inspection apparatus comprising:
a detector configured to emit light to a chamber in which reaction of a sample and a reagent occurs, and to detect an optical signal from the chamber; and
a controller configured to acquire optical property data based on the detected optical signal and to predict inspection results using the optical property data acquired before a reference time.

2. The apparatus according to claim 1, further comprising a storage configured to store a pattern of the optical property data for each of at least one or more inspection items.

3. The apparatus according to claim 2, wherein the pattern of the optical property data, stored in the storage, is determined based on an average value of the acquired optical property data.

4. The apparatus according to claim 2, wherein the controller is configured to search the storage for the pattern of the optical property data corresponding to a current inspection item, and predict the inspection results using the pattern of the optical property data corresponding to the current inspection item and the optical property data acquired before the reference time.

5. The apparatus according to claim 3, wherein the pattern of optical property data is at least one selected from the group including a linear pattern, a log pattern, an exponential pattern, and a polynomial pattern.

6. The apparatus according to claim 1, wherein the optical property of the optical signal is at least one selected from the group including optical density, transmittance, reflectance, and luminance.

7. The apparatus according to claim 1, further comprising a display configured to display the predicted inspection results.

8. The apparatus according to claim 7, wherein the display is configured to display a predetermined error percent of the predicted inspection results.

9. The apparatus according to claim 7, wherein the controller is configured to continuously acquire the optical property data until the inspection ends, and to determine an error percent by comparing final inspection results with the predicted inspection results, and
wherein the display is configured to display the error percent.

10. The apparatus according to claim 7, wherein the display is configured to display an input button for the user to predict inspection results.

11. The apparatus according to claim 7, wherein the reference time is a time when the input button is selected.

12. The apparatus according to claim 11, wherein the controller is configured to acquire the optical property data until the reference time.

13. The apparatus according to claim 1, wherein the detector is configured to emit light having a main wavelength and a sub wavelength to the chamber, and to detect a main wavelength signal corresponding to the light having the main wavelength, and to detect a sub wavelength signal corresponding to the light having the sub wavelength;
wherein the light having a main wavelength has an optical property that varies according to the reaction of the sample and the reagent, and the light having a sub wavelength has an optical property that is constant; and
wherein the controller is configured to acquire the optical property data based on the main wavelength signal and the sub wavelength signal.

14. The apparatus according to claim 13, wherein the reference time is a time when an abnormal state occurs.

15. The apparatus according to claim 14, wherein the controller is configured to determine the occurrence of the abnormal state based on variation of the sub wavelength signal.

16. The apparatus according to claim 15, wherein the controller is configured to monitor optical property variation of the light having the sub wavelength based on the sub wavelength signal, and to determine the occurrence of the abnormal state when the optical property of light having the sub wavelength varies beyond a critical value.

17. An inspection method comprising:
acquiring optical property data based on an optical signal detected from a chamber in which reaction of a sample and a reagent occurs by emitting light to the chamber; and
predicting inspection results using the optical property data acquired before a reference time.

18. The method according to claim 17, wherein the predicting includes:
searching for a pattern of optical property data corresponding to a current inspection item; and
predicting the inspection results using the pattern of the optical property data corresponding to the current inspection item and the optical property data acquired before the reference time.

19. The method according to claim 18, wherein the pattern of optical property data is determined by an average value of the acquired optical property data.

20. The method according to claim 18, wherein the pattern of optical property data is at least one selected from the group including a linear pattern, a log pattern, an exponential pattern, and a polynomial pattern.

21. The method according to claim 17, wherein the optical property is at least one selected from the group including optical density, transmittance, reflectance, and luminance.

22. The method according to claim 17, further comprising displaying the predicted inspection results on a display.

23. The method according to claim 17, further comprising displaying the predicted inspection results and a predetermined error percent on a display.

24. The method according to claim 17, further comprising:
continuously acquiring the optical property data until inspection ends; and
determining an error percent between final inspection results and the predicted inspection results.

25. The method according to claim 24, further comprising displaying both the final inspection results and the determined error percent.

26. The method according to claim 17, wherein the acquiring includes:
emitting light having a main wavelength and an optical property that varies according to reaction of the sample and the reagent, and emitting light having a sub wavelength and an optical property that is constant, to the chamber, and detecting a main wavelength signal corresponding to the light having the main wavelength and detecting a sub wavelength signal corresponding to the light having the sub wavelength; and
acquiring the optical property data based on the main wavelength signal and the sub wavelength signal.

27. The method according to claim 26, wherein the reference time is a time when an abnormal state, in which the sample is not normally received in the chamber, occurs.

28. The method according to claim 27, further comprising determining the occurrence of the abnormal state based on variation of the sub wavelength signal.

29. The method according to claim 28, wherein the determining includes monitoring the optical property variation of the light having the sub wavelength based on the sub wavelength signal, and determining the occurrence of the abnormal state when the optical property of the light having the sub wavelength varies beyond a critical value.

30. The method according to claim 28, wherein the determining includes determining that the sample and the reagent are abnormally received in the chamber when the sub wavelength signal varies beyond a critical value.
